(19) United States
(12) Patent Application Publication
(10) Pub. No.: US 2014/0085434 A1
(43) Pub. Date: Mar. 27, 2014

(54) IMAGE SIGNAL PROCESSING DEVICE AND IMAGE SIGNAL PROCESSING METHOD

(71) Applicant: Panasonic Corporation, Osaka (JP)

(72) Inventor: Yasunobu OGURA, Osaka (JP)

(73) Assignee: Panasonic Corporation, Osaka (JP)

(21) Appl. No.: 14/062,077

(22) Filed: Oct. 24, 2013

Related U.S. Application Data
(63) Continuation of application No. PCT/JP2013/000620, filed on Feb. 5, 2013.

(30) Foreign Application Priority Data
Sep. 25, 2012 (JP) 2012-210827

(51) Int. Cl. H04N 13/04

(52) U.S. Cl. CPC H04N 13/04
USPC 348/51

(57) ABSTRACT

An obtaining unit obtains, for a stereoscopic image signal, depth information indicating a depth value in each position in an image plane. A processing determination unit determines contents of smoothing processing in accordance with a predetermined condition. A smoothing unit smoothes the depth information in the image plane in accordance with the contents of the smoothing processing determined by the processing determination unit. An image generation unit generates, based on the depth information which has been smoothed, a new stereoscopic image from the stereoscopic image signal.

### CROSS-REFERENCE TO RELATED APPLICATION

This is a continuation of PCT International Application PCT/JP2013/000620 filed on Feb. 5, 2013, which claims priority to Japanese Patent Application No. 2012-210827 filed on Sep. 25, 2012. The disclosures of these applications including the specifications, the drawings, and the claims are hereby incorporated by reference in their entirety.

### BACKGROUND

The present disclosure relates to an image signal processing device that processes an input stereoscopic image signal.

Japanese Patent Publication No. 2001-175863 describes a technology in which highly accurate depth information is obtained by obtaining depth information from a stereoscopic image and performing smoothing processing and weighting processing, etc., on the depth information and a stereoscopic image from an arbitrary viewpoint is generated using the information.

The present disclosure may provide an image signal processing device that can generate a stereoscopic image having a more natural stereoscopic effect in accordance with a predetermined condition.

### SUMMARY

An image signal processing device according to an embodiment of the present disclosure is an image signal processing device which processes an input stereoscopic image, the device including an obtaining unit configured to obtain, for the stereoscopic image signal, depth information indicating a depth value in each position in an image plane, a processing determination unit configured to determine contents of smoothing processing in accordance with a predetermined condition, a smoothing unit configured to smooth the depth information in the image plane in accordance with the contents of smoothing processing determined by the processing determination unit, and an image generation unit configured to generate, on the basis of the depth information which has been smoothed, a new stereoscopic image from the stereoscopic image signal.

An image signal processing device according to an embodiment of the present disclosure may generate a stereoscopic image having a more preferable stereoscopic effect in accordance with a predetermined condition.

### BRIEF DESCRIPTION OF THE DRAWINGS

FIGS. 1A and 1B are views illustrating configuration examples employing an image signal processing device according to an embodiment.

FIG. 2 is a functional diagram of an image signal processing device according to an embodiment.

FIG. 3 is a flowchart illustrating processing of an image signal processing device according to an embodiment.

FIG. 4A is an example calculation expression used for calculating a filter coefficient in smoothing processing, FIG. 4B is a chart illustrating an example of filter coefficient in smoothing processing, and FIG. 4C is a chart illustrating an example of the relationship between parallax gradient and deviation σ.

FIG. 5 is a graph illustrating an example of the relationship between display panel size and filter size.

FIG. 6 is a graph illustrating an example of the relationship between viewing distance and filter size.

FIG. 7 is a graph illustrating an example of the relationship between parallax amount to be added and filter size.

FIGS. 8A-8E are views illustrating advantages of an embodiment.

### DETAILED DESCRIPTION

Embodiments will be described in detail below with reference to the attached drawings. However, unnecessarily detailed description might be omitted. For example, detail description of well-known techniques or description of the substantially same elements might be omitted. Such omission is intended to prevent the following description from being unnecessarily redundant and to help those skilled in the art easily understand it.

Note that the present inventors provide the following description and the attached drawings to enable those skilled in the art to fully understand the present disclosure. Thus, the description and the drawings are not intended to limit the scope of the subject matter defined in the claims.

A stereoscopic image includes a left-eye image and a right-eye image. A viewer perceives that a subject displayed in the left-eye image and the right-eye image is displaced from each other substantially in the horizontal direction, and thus, feels a stereoscopic effect (depth feeling) of the subject.

When a stereoscopic image at a new viewpoint position, which is different from that of an input stereoscopic image, is generated from the input stereoscopic image, a detected parallax (depth value) is not always accurate. Also, when contents to be displayed in a stereoscopic image at the new viewpoint position are not included in the original stereoscopic image, for example, an occlusion area, a parallax cannot be detected for the contents.

### First Embodiment

### 1-1. Configuration

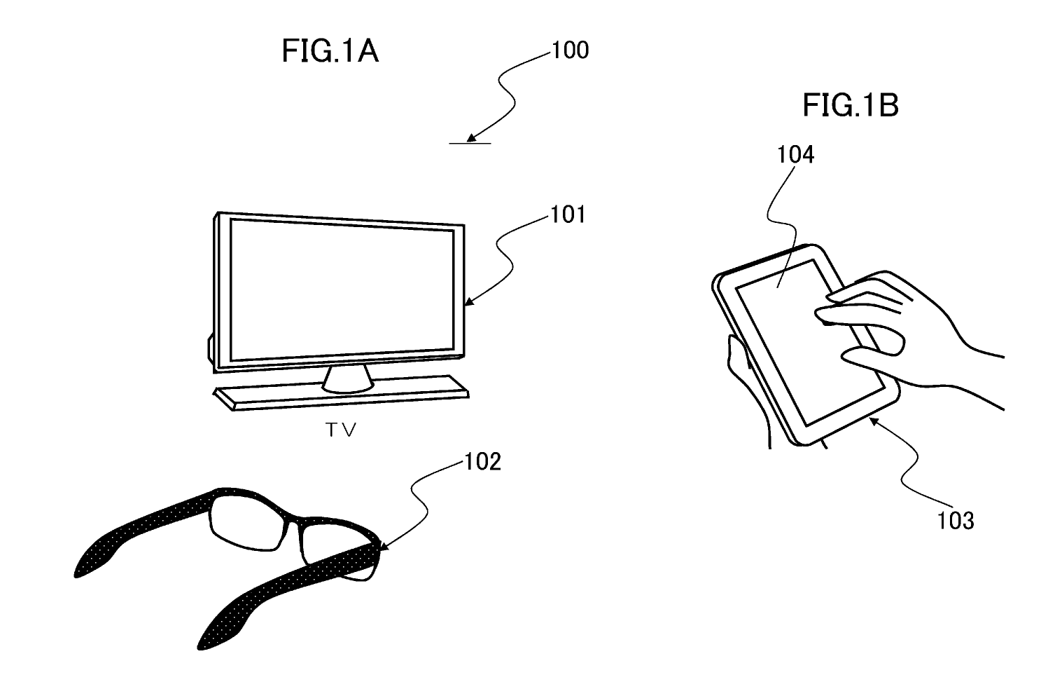

FIGS. 1A and 1B are views illustrating configuration examples employing an image signal processing device according to this embodiment. FIG. 1A illustrates a stereoscopic image system 100. The stereoscopic image system 100 includes a stereoscopic image display device 101 and a stereoscopic image viewing glasses 102. The stereoscopic image display device 101 displays a left-eye image and a right-eye image which form a stereoscopic image alternately in terms of time or by switching every certain number of frames. The stereoscopic image viewing glasses 102 operates in synchronized timing with a display timing with which the stereoscopic image display device 101 displays the left-eye image and the right-eye image.

Specifically, when the stereoscopic image display device 101 displays the left-eye image, the stereoscopic image viewing glasses 102 increases image light that enters the left eye of the viewer wearing the glasses 102 while reducing image light that enters the right eye. When the stereoscopic image display device 101 displays the right-eye image, the stereoscopic image viewing glasses 102 reduces image light that enters the left eye while increasing image light that enters the right eye.

Thus, the viewer views the left-eye image with the left eye and the right-eye image with the right eye and can perceive an image displayed by the stereoscopic image display device 101 as a stereoscopic image.

FIG. 1B is a view illustrating an example where a viewer views a stereoscopic image without using a pair of stereoscopic image viewing glasses. A tablet 103 includes an image display surface 104 that displays an image. The image display surface 104 employs a device, etc., that can display a stereoscopic image for naked-eye viewing. For example, a display having a lenticular parallax barrier function is used. The viewer sets the tablet 103 in a preferable position relative to the both eyes, and thus, can perceive an image displayed by the image display surface 104 as a stereoscopic image.

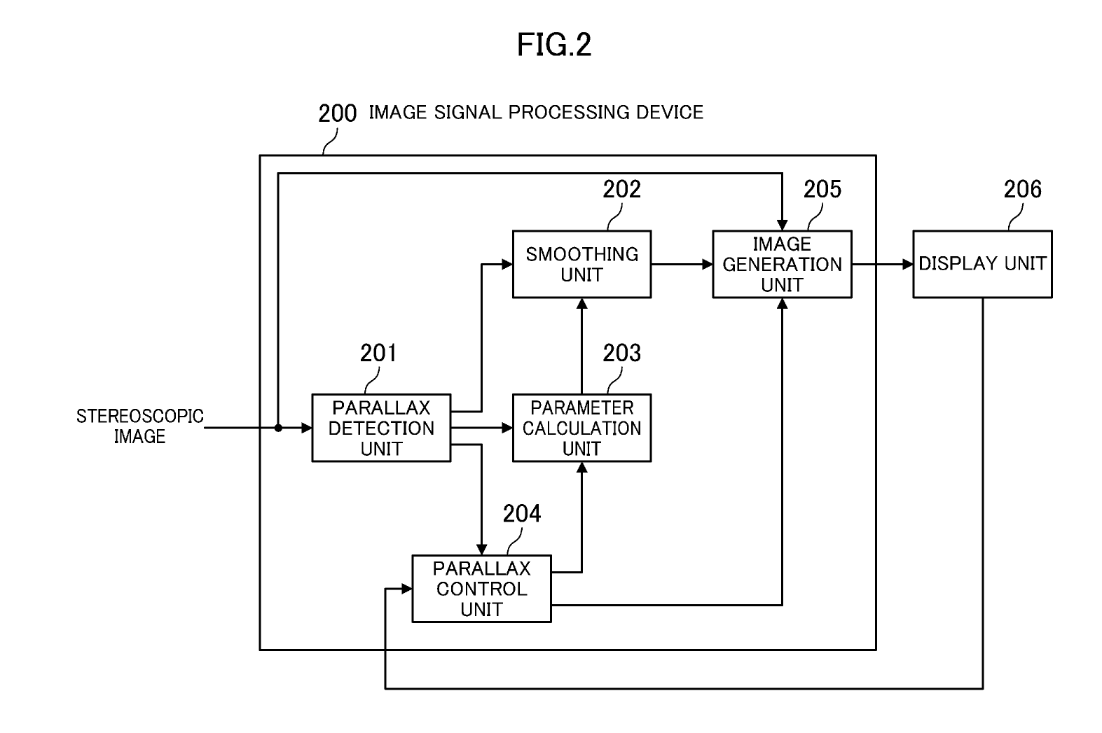

FIG. 2 is a functional diagram of an image signal processing device according to this embodiment. An image signal processing device 200 of FIG. 2 may be an independent device, and alternatively, may be a device, etc., provided in the stereoscopic image display device 101 of FIG. 1A or the tablet 103 of FIG. 1B, etc.

In FIG. 2, the image signal processing device 200 includes a parallax detection unit 201, a smoothing unit 202, a parameter calculation unit 203, a parallax control unit 204, and an image generation unit 205. The parameter calculation unit 203 and the parallax control unit 204 form a processing determination unit according to the present disclosure. The image signal processing device 200 receives an image signal of a stereoscopic image as an input, and outputs an image signal of a newly generated stereoscopic image. The output image signal of the new stereoscopic image is displayed by a display unit 206, etc.

The parallax detection unit 201 detects, from an input stereoscopic image signal, a parallax between a left-eye image and a right-eye image of a stereoscopic image. The parallax detection unit 201 detects a “displacement” in left and right images of the same subject etc. displayed in the left-eye image and the right-eye image of the stereoscopic image. It is thought that the greater the “displacement” is, the larger the parallax between the left and right images becomes. In contrast, it is thought that the smaller the “displacement” is, the smaller the parallax becomes. Note that, even in the same stereoscopic image, the magnitude of the “displacement” differs depending on the subject. In an image, the magnitude of the parallax (“displacement”) differs between a subject displayed in a foreground side and a subject displayed in a background side. Therefore, the parallax detection unit 201 divides an image plane into a plurality of areas and detects the parallax for each area in the image plane. Thus, a parallax distribution in the entire image plane can be obtained.

In the following description, a “parallax” means a “displacement” in an area of a stereoscopic image or a “depth” represented by the “displacement,” and a “parallax map” is, assuming that a “parallax” in an area is an element, a set of the “parallaxes” corresponding areas on an image plane of a stereoscopic image. The “parallax map” includes combined information of information indicating the “position” of each area and the “parallax” in the each area.

The parallax detection unit 201 detects the parallax as a depth value in each area of an input stereoscopic image and outputs the parallax map as depth information indicating the depth value in each position of the image plane for the entire stereoscopic image.

The smoothing unit 202 performs processing of smoothing the parallax map detected by the parallax detection unit 201 for the image plane. The purpose of this processing is to reduce error results etc. included in the parallax map obtained as a result of detection by the parallax detection unit 201 or to perform preferable processing etc. on an occlusion part or an area which is necessary in a stereoscopic image to be generated and is not indicated in the input stereoscopic image.

When the parallax is detected only from the input stereoscopic image, the reliability of the detected parallax might not be 100%. There might be cases where an error parallax is locally calculated. When a stereoscopic image is generated based on such an error parallax, a generated stereoscopic image includes inaccurate contents.

Moreover, the input stereoscopic image does not originally include information of an area (occlusion area) which is not indicated in the input stereoscopic image and is generated in a new stereoscopic image so as to correspond to a new viewpoint position. Thus, a generated stereoscopic image is highly likely to include inaccurate contents regarding the area.

Therefore, in order to reduce influences of the parallax detected incorrectly, or in order to preferably process the occlusion area etc., the smoothing unit 202 smoothes the calculated parallax in an area on the image plane using the parallax in an area surrounding the area in question. Thus, influences of the parallax calculated incorrectly can be reduced. Note that the details of processing of the smoothing unit 202 will be described later.

The parameter calculation unit 203 calculates various parameters for setting smoothing processing performed by the smoothing unit 202. That is, the parameter calculation unit 203 calculates a parameter, such as a filter size, a filter coefficient, etc., in order to specifically realize contents of smoothing processing determined by the parallax control unit 204.

The parallax control unit 204 determines contents of smoothing processing performed by the smoothing unit 202 on the basis of various conditions. As the various conditions herein, for example, there are (1) the magnitude of a parallax gradient (a change amount of the parallax) obtained from the detected parallax map, (2) a screen size of the display unit 206 that displays a stereoscopic image output by the image signal processing device 200, (3) an instruction from the viewer viewing a stereoscopic image, and (4) a viewing distance between the display unit 206 and the viewer, etc. The parallax control unit 204 determines processing contents in the smoothing unit 202 on the basis of the above-described conditions.

The image generation unit 205 generates an image signal of a new stereoscopic image from an input stereoscopic image signal on the basis of the parallax map processed by the smoothing unit 202. The image generation unit 205 outputs the generated stereoscopic image signal to the display unit 206 etc.

### 1-2. Operation

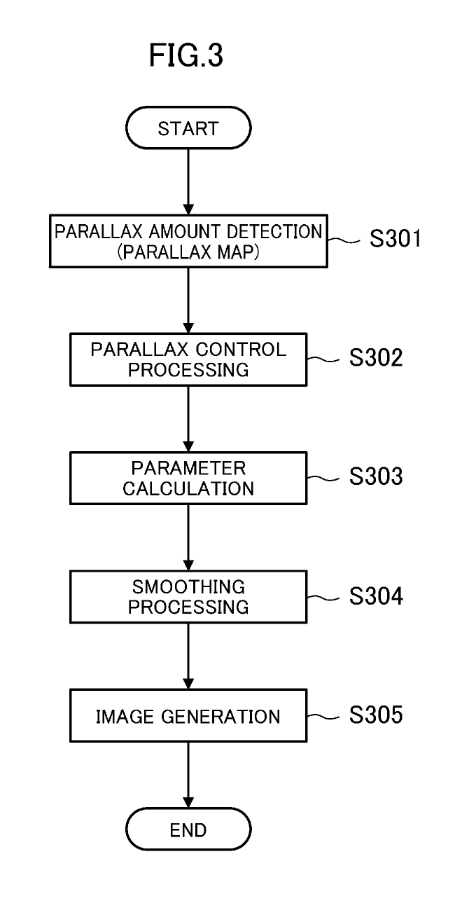

FIG. 3 is a flowchart illustrating a flow in which the image signal processing device 200 processes a stereoscopic image signal, etc.

### (Step S301)

The parallax detection unit 201 detects, from a left-eye image and a right-eye image of an input stereoscopic image, a parallax in each area of each of the images. The parallax detection unit 201 forms a parallax map by distributing the parallax calculated in each area to the entire screen in accordance with a corresponding area.

### (Step S302)

The parallax control unit 204 determines contents of smoothing processing performed in the smoothing unit 202 in accordance with a predetermined condition.

The parallax control unit 204 detects, for example, a parallax gradient from change in the parallax for each adjacent areas, etc., on the basis of the parallax map obtained in the parallax detection unit 201. In accordance with the parallax gradient, the parallax control unit 204 sets the filter coefficient etc. used in smoothing processing, which will be described later, to be preferable one.

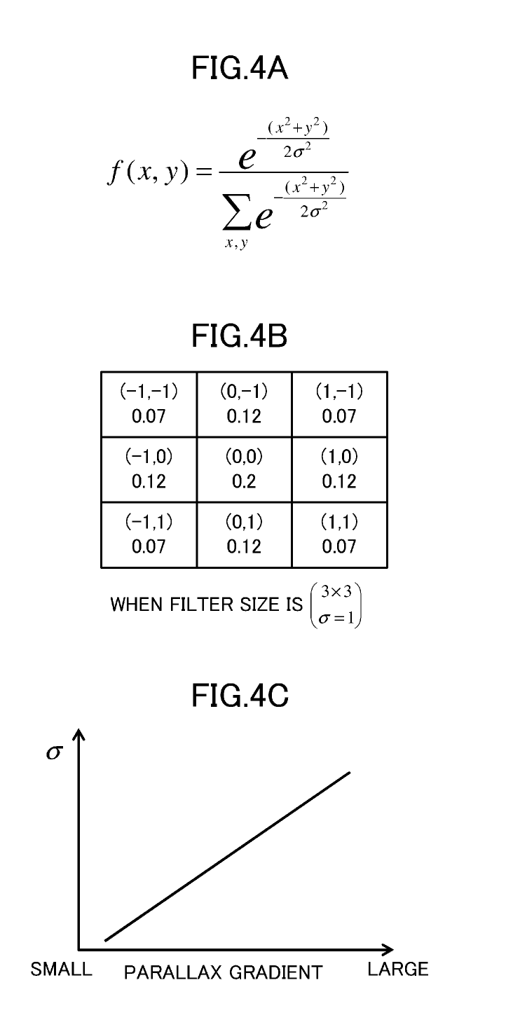

FIG. 4A is an example calculation expression used in smoothing processing. In the expression of FIG. 4A, (x, y) indicates relative positional coordinates of each area within a range in which smoothing processing is performed. The coordinates of a central area are (0, 0), an x axis is set to extend in the horizontal direction, and a y axis is set to extend in the vertical direction. Also, a denotes a deviation, as the value a increases, the degree of influence in a surrounding area increases, and as the value a reduces, the degree of influence in the central area increases. The value of f(x, y) is a filter coefficient of the area indicated by the coordinates (x, y). Note that the filter coefficient f(x, y) is normalized such that the total is 1 in the entire filter.

FIG. 4B is a chart illustrating an example of the filter coefficient obtained from the calculation expression indicated by FIG. 4A. The upper line of each area indicates the positional coordinates (x, y) of the each area, and the lower line thereof indicates a value calculated by the expression of FIG. 4A. FIG. 4B illustrates a case where the filter size is three rows and three columns, and the value of the deviation σ is 1.

FIG. 4C is a chart illustrating an example of the relationship between the magnitude of the parallax gradient and the deviation σ used for the filter coefficient. In the example of FIG. 4C, as the parallax gradient increases, the value of deviation σ increases. That is, in an area where the change in parallax is great, the value of the deviation σ is increased, and the degree of influence of the parallax in the surrounding area is increased in smoothing processing. Thus, when the parallax is large only in a particular area, the parallax is smoothed so as to be closer to the parallax of the surrounding area and, on the other hand, when not only the parallax in a particular area but also the parallax in the surrounding area is large, smoothing is performed with the large parallax being held.

### (Step S303)

The parameter calculation unit 203 determines a specific parameter, such as the filter size, the filter coefficient, in accordance with the contents of smoothing processing determined by the parallax control unit 204. For example, the filter size and the filter coefficient illustrated in FIG. 4B may be adopted. Thus, an actual parameter corresponding to smoothing processing in accordance with each purpose is determined.

### (Step S304)

The smoothing unit 202 performs smoothing processing of the parallax map calculated by the parallax detection unit 201 using the parameter calculated by the parameter calculation unit 203.

### (Step S305)

The image generation unit 205 generates a stereoscopic image at a new viewpoint from the left-eye image and the right-eye image of the input stereoscopic image, on the basis of the parallax map smoothed by the smoothing unit 202. Specifically, on the basis of the parallax map smoothed by the smoothing unit 202, a parallax map at a new viewpoint position is generated. The image generation unit 205 displaces, in accordance with the parallax map at the new viewpoint position, contents of each area of the left-eye image of the input stereoscopic image by the parallax corresponding to the area in question. Thus, a new right-eye image is generated, and a new stereoscopic image formed of the original left-eye image and the generated right-eye image is generated.

Note that a case where a right-eye image is generated on the basis of a left-eye image has been described, but the contents disclosed in this embodiment are not limited thereto. A left-eye image may be generated on the basis of a right-eye image. Alternatively, both of left-eye and right-eye images may be newly generated. As long as an image is generated using the parallax map processed by the smoothing unit 202, any method may be used.

Note that the parallax control unit 204 may determine contents of smoothing processing in accordance with a condition other than the parallax gradient.

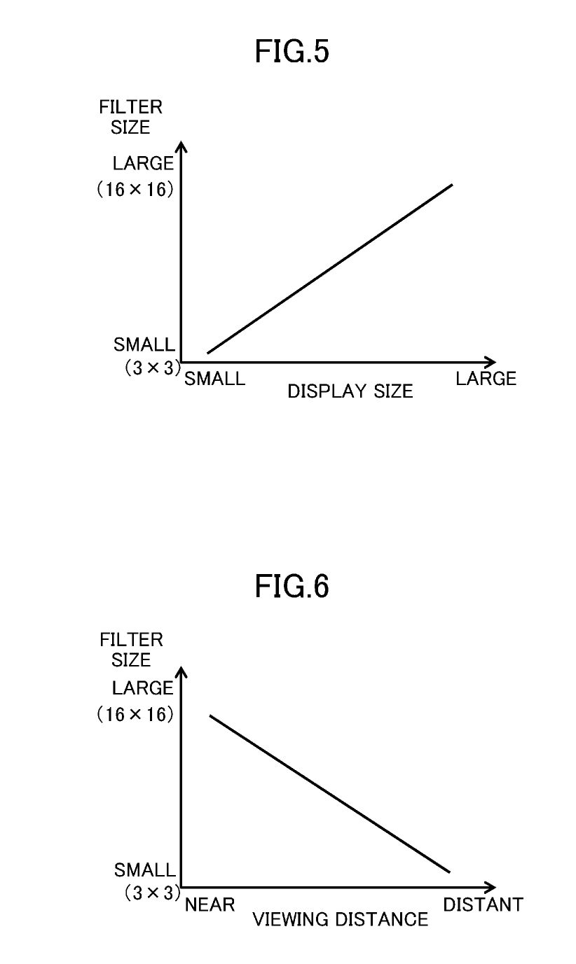

For example, the parallax control unit 204 may determine contents of smoothing processing in accordance with the size of the display panel of the display unit 206 that displays a stereoscopic image to be output. FIG. 5 is a graph illustrating an example of the relationship between the size (display size) of the display panel of the display unit 206 and a filter size used in smoothing processing. In FIG. 5, as the display size increases, the filter size increases. “The filter size increases” means that the number of surrounding areas that gives an influence to smoothing processing of an area increases. Thus, the parallax gradient after smoothing processing tends to be more moderate. That is, a more preferable stereoscopic image can be presented to the viewer by changing the filter size in smoothing processing in accordance with the size of the display panel. Note that, in FIG. 5, the filter size and the display size have a linear relationship, but the relationship therebetween is not limited thereto.

The parallax control unit 204 may determine contents of smoothing processing in accordance with a viewing distance between the display panel of the display unit 206 and the viewer viewing the stereoscopic image. FIG. 6 is a graph illustrating an example of the relationship between the viewing distance and the filter size. In FIG. 6, as the viewing distance reduces, the filter size increases. The reason for this is as follows. When the viewing distance reduces, the parallax perceived by the eye increases as a distance to the display panel reduces. In that case, it is considered more preferable to cause the parallax gradient to be moderate to increase a blur effect. That is, a more preferable stereoscopic image can be presented to the viewer by changing the filter size in smoothing processing in accordance with the viewing distance. Note that information of the viewing distance may be detected, for example, by a distance sensor etc. In FIG. 6, the filter size and the viewing distance have a linear relationship, but the relationship therebetween is not limited thereto.

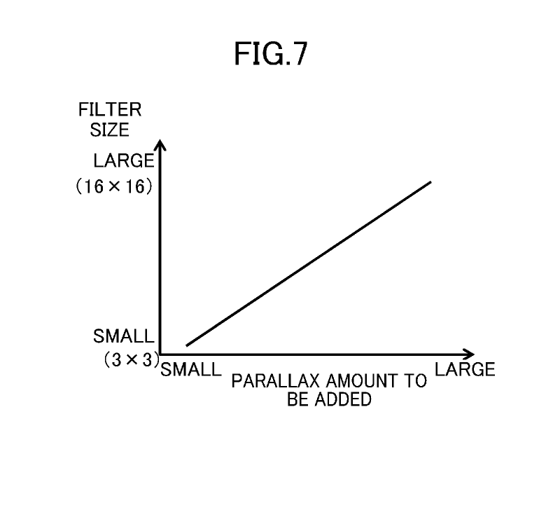

The parallax control unit 204 may determine contents of smoothing processing in accordance with a request from the viewer. For example, in a system including the image signal processing device according to the present disclosure, a stereoscopic effect of a stereoscopic image can be adjusted in accordance with the preference of a user. That is, the user may determine the parallax amount to be added to a stereoscopic image. FIG. 7 is a graph illustrating an example of the relationship between the parallax amount to be added, which is set by the user, and the filter size. In FIG. 7, as the parallax amount to be added increases, the filter size increases. This is because it is considered preferable that, when the parallax amount to be added is large, the parallax gradient is caused to be moderate to increase the blur effect. Thus, smoothing processing close to the viewer's preference can be performed. That is, a more preferable stereoscopic image can be presented to the viewer by changing the filter size in smoothing processing on the basis of a request from the viewer. Note that, in FIG. 7, the filter size and the parallax amount to be added have a linear relationship, but the relationship therebetween is not limited thereto.

### 1-3. Advantages, etc.

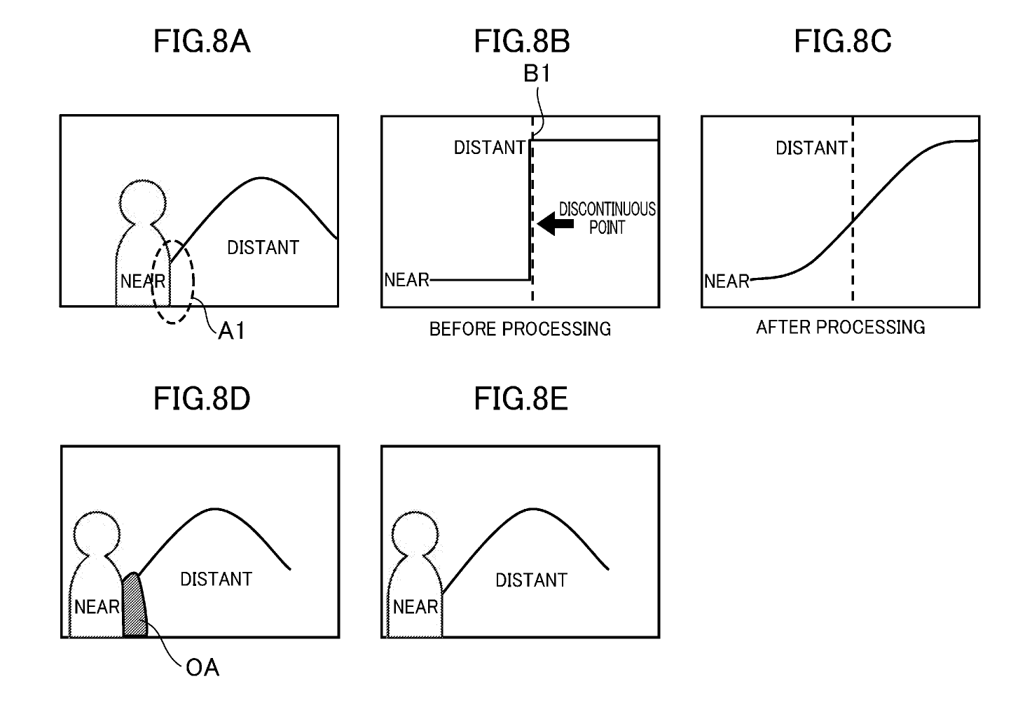

FIGS. 8A-8E are views illustrating advantages of this embodiment. FIG. 8A is a view illustrating an example stereoscopic image input to the image signal processing device 200, which includes a foreground (near view) area, such as a person etc., (in FIG. 8A, indicated by “NEAR”) and a background (distant view) area, such as a landscape etc., (in FIG. 8A, indicated by “DISTANT.” An area A1 indicates a part serving as a boundary of the foreground area and the background area.

The image signal processing device 200 detects a parallax from an input stereoscopic image by the parallax detection unit 201. FIG. 8B is a view illustrating change in parallax in the area A1. In FIG. 8B, the upper part is a background side, the lower part is a foreground side, and the transverse direction corresponds to the horizontal direction of the image of FIG. 8A. In this case, the detected parallax discontinuously changes at a boundary B1 of the foreground and the background.

When the boundary B1 matches the boundary on the image of the foreground area and the background area included in the area A1 of FIG. 8A, there is no problem. However, in parallax detection, it is difficult to ensure 100% reliability, and therefore, there might be cases where the boundary on the image and the boundary of the parallax do not always match. In this case, when a new stereoscopic image is generated on the basis of the parallax detected by the parallax detection unit 201, an unnatural stereoscopic image might be obtained.

FIG. 8C is a view illustrating change in parallax in the area A1 after the smoothing unit 202 has performed smoothing processing on the parallax map detected by the parallax detection unit 201. In this case, preferable smoothing processing is performed in accordance with various conditions. In FIG. 8C, the parallax continuously changes in a moderate manner around the boundary of the foreground and the background. Thus, a range in which the parallax changes, i.e., a range of the boundary of the foreground and the background substantially expands. Thus, even when the boundary on the image and the boundary of the parallax detected do not accurately match, mismatch of the boundaries is less distinctive because the boundary of the parallax is expanded by smoothing processing of the parallax map. Therefore, unnaturalness of the new stereoscopic image can be reduced.

An example case where a stereoscopic image is newly generated from an input stereoscopic image on the basis of the parallax map will be described below. FIG. 8D is a view illustrating an example case where the viewpoint position is displaced to right, as compared to the stereoscopic image of FIG. 8A, and a subject is generally shifted to the left of the image plane. When such a stereoscopic image is newly generated, there is no information regarding a part which is not displayed in the original stereoscopic image, i.e., an occlusion area OA, located between the foreground and the background, and therefore, it is difficult to accurately generate a stereoscopic image.

Thus, for the occlusion area OA, when a new stereoscopic image is generated using the parallax map in which the parallax discontinuously changes between the foreground and the background, as illustrated in FIG. 8B, an erroneous image might be obtained. For example, for the occlusion area OA, when an image is generated by performing interpolation using image contents of the foreground side and image contents of the background side, the part of the foreground side in the area A1 of the original stereoscopic image might be mis-displayed as an area including the parallax of the background side. In this case, the part that is a foreground in terms of logical contents of an image is displayed as a background area in a visual manner, and therefore, a very unnatural stereoscopic image is obtained.

On the other hand, using the parallax map to which smoothing processing has been performed, the above-described problem can be reduced. That is, in the occlusion area OA, as illustrated in FIG. 8C, the parallax moderately changes, and therefore, a phenomenon in which the relationship between logical contents of an image and the actual parallax amount becomes contrary is less likely to occur. Accordingly, even when image contents regarding the occlusion area OA are not always displayed in an accurate manner, a stereoscopic image that providing less feeling of strangeness, as illustrated in FIG. 8E, can be generated.

As described above, in this embodiment, the image signal processing device 200 includes the parallax detection unit 201 that serves as an obtaining unit, the smoothing unit 202, the parameter calculation unit 203 and the parallax control unit 204 that serve as a processing determination unit, and the image generation unit 205. The parallax detection unit 201 obtains, for an input stereoscopic image, a parallax map that indicates a parallax in each position of an image plane. The parameter calculation unit 203 and the parallax control unit 204 determine contents of smoothing processing in accordance with a predetermined condition. The smoothing unit 202 smoothes the parallax map in the image plane in accordance with the contents of smoothing processing determined by the parameter calculation unit 203 and the parallax control unit 204. The image generation unit 205 generates a new stereoscopic image from the input stereoscopic image on the basis of the smoothed parallax map.

Thus, the parallax map is smoothed in accordance with the contents of smoothing processing determined in accordance with the predetermined condition. Then, a new stereoscopic image is generated on the basis of the smoothed parallax map. Therefore, a natural stereoscopic image in accordance with the predetermined condition can be generated.

Herein, the predetermined conditions include, for example, the parallax gradient in the parallax map, the size of the display panel that displays a new stereoscopic image, the viewing distance between the display panel and the viewer, and a request from the viewer, etc. A more natural stereoscopic image meeting each condition can be generated by determining contents of smoothing processing, i.e., for example, the filter size and the filter coefficient, etc., in accordance with the each condition.

### Other Embodiments

The first embodiment has been described above to illustrate examples of the technology of the present disclosure. However, the technology of the present disclosure is not limited thereto, and may be applied to embodiments where modifications, replacement, addition, and deletions, etc., are made. Also, a new embodiment may be devised by combining one of the components described in the first embodiment with another.

In the above-described first embodiment, the parallax map is detected from the stereoscopic image signal. The parallax map may be, for example, given with the stereoscopic image signal from the outside. Also, the parallax map is an example of the depth information, and for the depth information indicating the depth value in each position in the image plane of the stereoscopic image, the contents of the present disclosure can be used.

In the above-described first embodiment, contents of smoothing processing is determined by the parameter calculation unit 203 and the parallax control unit 204, but the configuration of the processing determination unit is not limited thereto. For example, a configuration in which a single processing unit determines contents of smoothing processing in accordance with a predetermined condition may be adopted.

In the above-described first embodiment, an image signal processing device has been described as an example. However, the contents of the present disclosure are not limited thereto. As another method for implementing the present disclosure, an image signal processing method in which a program that realizes the above-described processing, i.e., for example, the processing flow illustrated in FIG. 3, is mounted and the program is operated on an arithmetic device, such as a CPU etc. can be employed.

The components described in the attached drawings and the detailed description may include not only a component essential for solving the problems but also components non-essential for solving the problems, in order to illustrate the technology described above. Thus, the non-essential components should not immediately recognized as being essential because the non-essential components are described in the attached drawings and the detailed description.

The above-described embodiments are intended to illustrate examples of the technology of the present disclosure. Therefore, various modifications, replacement, addition, and deletions, etc. may be applied to the components within the scope of claims or within the equivalent scope.

The present disclosure is applicable to an image signal processing device which generates a more natural stereoscopic image. Specifically, the present disclosure is effective for a TV set, and a tablet, etc., which displays a stereoscopic image, and a recorder which records and plays back a stereoscopic image, etc.

What is claimed is:

1. An image signal processing device which processes an input stereoscopic image signal, the device comprising:
an obtaining unit configured to obtain, for the stereoscopic image signal, depth information indicating a depth value in each position in an image plane;
a processing determination unit configured to determine contents of smoothing processing in accordance with a predetermined condition;
a smoothing unit configured to smooth the depth information in the image plane in accordance with the contents of smoothing processing determined by the processing determination unit; and
an image generation unit configured to generate, on the basis of the depth information which has been smoothed, a new stereoscopic image from the stereoscopic image signal.

2. The image signal processing device of claim 1, wherein
the predetermined condition is a gradient of the depth value in the depth information, and
the processing determination unit determines the contents of smoothing processing such that as the gradient of the depth value increases, a degree of influence of a depth value in a surrounding area in smoothing increases.

3. The image signal processing device of claim 1, wherein
the predetermined condition is a size of a display panel that displays the new stereoscopic image, and
the processing determination unit changes, on the basis of the size of the display panel, a filter size in the smoothing processing.

4. The image signal processing device of claim 1, wherein
the predetermined condition is a viewing distance between a display panel that displays the new stereoscopic image and a viewer viewing the new stereoscopic image, and
the processing determination unit changes, on the basis of the viewing distance, a filter size in the smoothing processing.

5. The image processing device of claim 1, wherein
the predetermined condition is a request from a viewer viewing the new stereoscopic image, and
the processing determination unit changes, on the basis of the request, a filter size in the smoothing processing.

6. An image signal processing method for processing a stereoscopic image signal, the method comprising:
obtaining, for the stereoscopic image signal, depth information indicating a depth value in each position in an image plane;
determining contents of smoothing processing in accordance with a predetermined condition;
smoothing the depth information in the image plane in accordance with the determined contents of smoothing processing; and
generating, on the basis of the depth information which has been smoothed, a new stereoscopic image from the stereoscopic image signal.
